(19) United States
(12) Patent Application Publication
(10) Pub. No.: US 2009/0109257 A1
(43) Pub. Date: Apr. 30, 2009

(54) FLUID EJECTING APPARATUS

(75) Inventor: Jun SHIMAZAKI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/255,804

(22) Filed: Oct. 22, 2008

(30) Foreign Application Priority Data
Oct. 24, 2007 (JP) 2007-276463
Oct. 24, 2007 (JP) 2007-276525

(51) Int. Cl. B41J 2/165

(52) U.S. Cl. 347/31

(57) ABSTRACT

A fluid ejecting apparatus that ejects a fluid includes a head that ejects the fluid, a first moisturizing cap device that covers the head to moisturize the head, and a first moisturizing liquid supply portion that supplies, to the first moisturizing cap device, a first moisturizing liquid for moisturizing the head when the first moisturizing cap device covers the head. The first moisturizing liquid supply portion has a first tank that stores the first moisturizing liquid. The first moisturizing cap device has a first moisturizing liquid storage portion that stores the first moisturizing liquid to be supplied from the first moisturizing liquid supply portion. The first moisturizing liquid supply portion supplies the first moisturizing liquid stored in the first tank to the first moisturizing cap device in accordance with a water head difference between the first moisturizing liquid stored in the first tank and the first moisturizing liquid storage portion.

### CROSS-REFERENCE TO RELATED APPLICATIONS

This application is based upon and claims the benefit of priority from prior Japanese Patent Applications No. 2007-276463, filed on Oct. 24, 2007, the entire contents of which are incorporated herein by reference.

### BACKGROUND

1. Technical Field

The present invention relates to a technology for resolving nozzle clogging in a fluid ejecting apparatus, which ejects a fluid.

2. Related Art

In an ink jet recording apparatus that ejects ink onto a recording sheet through nozzles, residual ink may be thickened around the nozzles and the nozzles may become clogged. Ink thickening or nozzle clogging causes ink to be abnormally ejected. To suppress ink thickening or nozzle clogging, an ink jet recording apparatus has been suggested in which, in a state where printing is not executed, a head is covered with a moisturizing cap device and moisture is supplied into a space of the moisturizing cap device to moisturize the head, thereby preventing residual ink from being dried (see JP-A-2003-334962).

In this ink jet recording apparatus, when moisture is insufficiently supplied to the moisturizing cap device or when moisture supplied to the moisturizing cap device is insufficiently evaporated in the space of the moisturizing cap device covering the head, the head may be insufficiently moisturized. For this reason, residual ink of the nozzles may be thickened.

In addition to the ink jet recording apparatus, a fluid ejecting apparatus that ejects a fluid (including a liquid, a liquid-state material with particles of a functional material dispersed, or a solid, such as powder capable of being ejected as a fluid) other than ink may also have the above-described problem.

### SUMMARY

An advantage of some aspects of the invention is that it provides a technology for sufficiently humidifying the inside of a moisturizing cap device.

The invention may be embodied as the following aspects.

According to an aspect of the invention, a fluid ejecting apparatus that ejects a fluid includes a head that ejects the fluid, a first moisturizing cap device that covers the head to moisturize the head, and a first moisturizing liquid supply portion that supplies, to the first moisturizing cap device, a first moisturizing liquid for moisturizing the head when the first moisturizing cap device covers the head. The first moisturizing liquid supply portion has a first tank that stores the first moisturizing liquid. The first moisturizing cap device has a first moisturizing liquid storage portion that stores the first moisturizing liquid to be supplied from the first moisturizing liquid supply portion. The first moisturizing liquid supply portion supplies the first moisturizing liquid stored in the first tank to the first moisturizing cap device in accordance with a water head difference between the first moisturizing liquid stored in the first tank and the first moisturizing liquid storage portion.

With this fluid ejecting apparatus, the first moisturizing liquid supply portion supplies the first moisturizing liquid to the first moisturizing cap device in accordance with the water head difference between the first moisturizing liquid stored in the first tank and the first moisturizing liquid storage portion. Therefore, it is possible to supply a large amount of moisturizing liquid to the first moisturizing cap device, and as a result, it is possible to sufficiently humidify the inside of the first moisturizing cap device.

In the fluid ejecting apparatus according to the aspect of the invention, when the first moisturizing liquid supply portion supplies the first moisturizing liquid stored in the first tank to the first moisturizing cap device, the water head of the first moisturizing liquid stored in the first tank may become higher than the water head of the first moisturizing liquid stored in the first moisturizing liquid storage portion. When the first moisturizing liquid supply portion does not supply the first moisturizing liquid stored in the first tank to the first moisturizing cap device, the water head of the first moisturizing liquid stored in the first tank may become lower than the water head of the first moisturizing liquid stored in the first moisturizing liquid storage portion.

With this configuration, by adjusting the position of the water head of the first moisturizing liquid stored in the first tank or the position of the first moisturizing liquid storage portion, it is possible to control whether or not to supply the first moisturizing liquid to the first moisturizing cap device. Therefore, the first moisturizing liquid can be prevented from being continuously supplied to the first moisturizing cap device. As a result, it is possible to suppress the amount of consumption of the first moisturizing liquid.

In the fluid ejecting apparatus according to the aspect of the invention, the first moisturizing cap device may have an absorption member that is capable of absorbing the first moisturizing liquid. When the first moisturizing liquid supply portion supplies the first moisturizing liquid to the first moisturizing cap device, the position of a top surface of the absorption member may become lower than the water head of the first moisturizing liquid stored in the first tank.

With this configuration, the absorption member can absorb and retain the first moisturizing liquid. In addition, the first moisturizing liquid absorbed by the absorption member is evaporated, thereby humidifying the head.

In the fluid ejecting apparatus according to the aspect of the invention, the first moisturizing cap device may have a hollow shape, and the first moisturizing liquid storage portion may be formed by a concave portion that is formed at a bottom portion of the first moisturizing cap device. When the first moisturizing liquid supply portion supplies the first moisturizing liquid to the first moisturizing cap device, the position of a top surface of the concave portion may become lower than the water head of the first moisturizing liquid stored in the first tank.

With this configuration, the first moisturizing liquid can be stored in the concave portion. In addition, the first moisturizing liquid stored in the concave portion is evaporated, thereby humidifying the head.

The fluid ejecting apparatus according to the aspect of the invention may further include a lift portion that raises and lowers at least one of the first moisturizing cap device and the first tank. The first moisturizing liquid supply portion may move the first moisturizing cap device down or may move the first tank up by using the lift portion to supply the first moisturizing liquid stored in the first tank to the first moisturizing cap device in accordance with the water head difference.

With this configuration, the first moisturizing cap device is moved down or the first tank is moved up by using the lift portion. Therefore, the water head difference can be formed between the first moisturizing liquid stored in the first tank and the first moisturizing liquid stored in the first moisturizing liquid storage portion.

The fluid ejecting apparatus according to the aspect of the invention may further include a cap device for preliminary ejection that receives the fluid when the head executes preliminary ejection separately from effective ejection, in which the fluid is ejected onto an object to be processed disposed at a predetermined position, a second moisturizing cap device that covers the cap device for preliminary ejection to moisturize the cap device for preliminary ejection, and a second moisturizing liquid supply portion that supplies a second moisturizing liquid for moisturizing the cap device for preliminary ejection to the second moisturizing cap device. The second moisturizing liquid supply portion may have a second tank that stores the second moisturizing liquid. The second moisturizing cap device may have a second moisturizing liquid storage portion that stores the second moisturizing liquid to be supplied from the second moisturizing liquid supply portion. The cap device for preliminary ejection may be disposed in the second moisturizing cap device. The second moisturizing cap device may come into contact with the bottom of the first moisturizing cap device and is stacked on the first moisturizing cap device in order to moisturize the cap device for preliminary ejection. The second moisturizing liquid supply portion may supply the second moisturizing liquid stored in the second tank to the second moisturizing cap device in accordance with a water head difference between the second moisturizing liquid stored in the second tank and the second moisturizing liquid storage portion.

With this configuration, the inside of the second moisturizing cap device can be sufficiently humidified. In addition, during preliminary ejection, the fluid received by the cap device for preliminary ejection can be prevented from being dried.

In the fluid ejecting apparatus according to the aspect of the invention, the fluid may be a liquid.

With this configuration, it is possible to prevent the liquid stuck to the head from being dried and thickened or solidified.

### BRIEF DESCRIPTION OF THE DRAWINGS

The invention will be described with reference to the accompanying drawings, wherein like numbers reference like elements.

FIG. 1 is an explanatory view showing the schematic configuration of an ink jet printer as a fluid ejecting apparatus according to an example of the invention.

FIG. 2 is an explanatory view showing the detailed configuration of a portion near a home position H1 in a power-off state according to a first example.

FIG. 3 is an explanatory view showing the detailed configuration of a portion near the home position H1 during printing according to the first example.

FIG. 4 is an explanatory view showing the detailed configuration of a portion near a home position H1 in a power-off state according to a second example.

FIG. 5 is an explanatory view showing the detailed configuration of a portion near the home position H1 during printing according to the second example.

FIG. 6 is an explanatory view showing the detailed configuration of a portion near a home position H1 in a power-off state according to a third example.

FIG. 7 is an explanatory view showing the detailed configuration of a portion near the home position H1 during printing according to the third example.

FIG. 8 is an explanatory view showing the detailed configuration of a portion near a home position H1 in a power-off state according to a fourth example.

FIG. 9 is an explanatory view showing the detailed configuration of a portion near the home position H1 during printing according to the fourth example.

FIG. 10 is an explanatory view showing the detailed configuration of a portion near the home position H1 during suction and recovery according to the fourth example.

FIG. 11 is an explanatory view showing the detailed configuration of a portion near the home position H1 during suction and recovery according to the fourth example.

FIG. 12 is an explanatory view showing the detailed configuration of a moisturizing cap device according to a fifth example.

FIG. 13 is an explanatory view showing the detailed configuration of a moisturizing cap device according to a sixth example.

FIG. 14 is an explanatory view showing the detailed configuration of a moisturizing cap device according to a seventh example.

FIG. 15 is an explanatory view showing the detailed configuration of an absorption member used for a moisturizing cap according to an eighth example.

### DESCRIPTION OF EXEMPLARY EMBODIMENTS

Hereinafter, an exemplary embodiment of the invention will be described in connection with the following examples.

### FIRST EXAMPLE

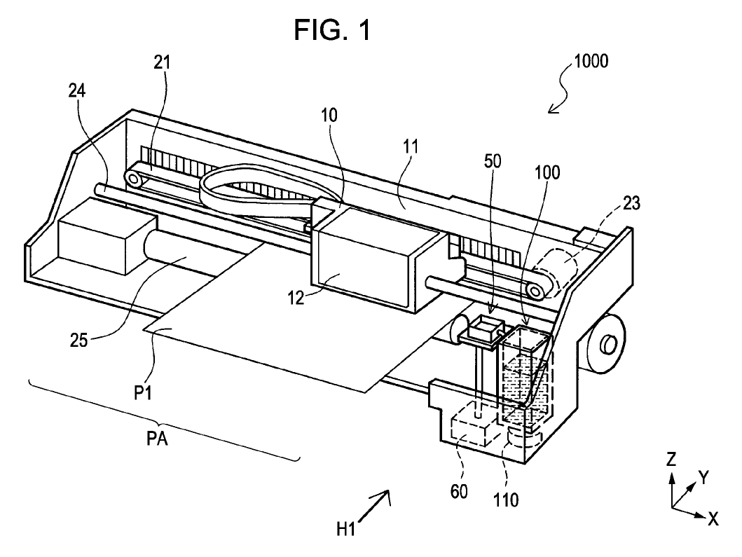

FIG. 1 is an explanatory view showing the schematic configuration of an ink jet printer as a fluid ejecting apparatus according to an example of the invention. A printer 1000 has a frame 11, and a platen 25 is arranged in the frame 11. A print sheet P1 is fed onto the platen 25 by a sheet feed mechanism (not shown). The printer 1000 also has a carriage 10. The carriage 10 is supported by a guide member 24 so as to be movable in a longitudinal direction (X-axis direction) of the platen 25, and reciprocates by means of a carriage motor 23 through a timing belt 21.

An ink cartridge 12 is mounted on the carriage 10. An ink jet recording head (hereinafter, simply referred to as “head”) (not shown) is attached at a lower part of the carriage 10. The carriage 10 is moved along the platen 25, and transports the head (not shown) so as to reciprocate on the print sheet P1. At this time, ink is ejected from the head (not shown), and thus printing is executed.

In the frame 11, a non-printing area where ink is not ejected is provided on a side of an area (hereinafter, referred to as “printing area”) PA where ink can be ejected from the head (not shown). A home position H1 is provided in the non-printing area. The carriage 10 reciprocates between the printing area PA and the home position H1.

Arranged at the home position H1 are a moisturizing cap device 50, a moisturizing cap device lift unit 60, a water tank 100, and a water tank lift unit 110. The moisturizing cap device 50 is arranged so as to cover an ejection surface of the head (not shown) in a power-off state. The reason for this is as follows. After printing or flushing (a predetermined amount of ink is ejected from all nozzles, in an operation separate from printing, to remove thickened ink), ink droplets may be stuck to the ejection surface of the head (not shown) or inside the nozzles. In this case, if ink stuck to the ejection surface is dried, the nozzles become clogged, and accordingly ink is not normally ejected. For this reason, in order to prevent ink stuck to the ejection surface from being dried, the ejection surface of the head (not shown) is covered with the moisturizing cap device 50 in a power-off state.

The moisturizing cap device lift unit 60 moves the moisturizing cap device 50 up and down in a vertical direction. As the moisturizing cap device lift unit 60, for example, a known lift mechanism, such as a mechanism including a motor and a screw, may be used. The water tank 100 stores water therein, and supplies moisture for moisturizing the head to the moisturizing cap device 50. As a moisturizing liquid for moisturizing the head, instead of water, any liquid, such as glycerin, may be used insofar as it can moisturize residual ink.

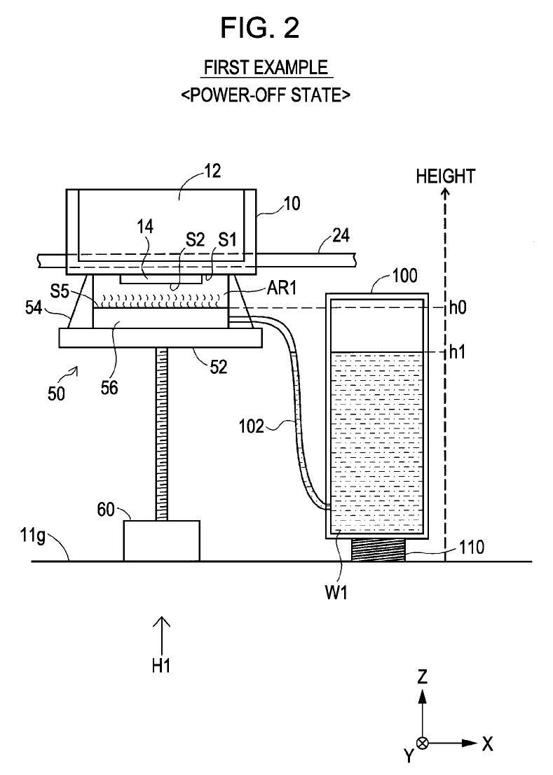

FIG. 2 is an explanatory view showing the detailed configuration of a portion near the home position H1 in a power-off state according to a first example. In a state where the printer 1000 is powered-off, the carriage 10 is arranged at the home position H1. Even in a power-on state, when printing or flushing is not executed (standby state) the carriage 10 and the moisturizing cap device 50 are arranged as shown in FIG. 2.

The water tank 100 and the moisturizing cap device 50 are connected to each other by a tube 102. One end of the tube 102 is connected to the inside of the water tank 100, such that water W1 in the water tank 100 flows into the tube 102. The water head of the water W1 in the water tank 100 is set at a height h1 from a frame bottom surface 11g. The water tank lift unit 110 is arranged below the water tank 100. The water tank lift unit 110 adjusts the position of the water tank 100 such that the water head of the water W1 is substantially kept at the height h1 even if the water W1 in the water tank 100 is supplied to the moisturizing cap device 50 and decreased. The water tank lift unit 110 may be formed by, for example, a spring. In this case, as the amount of the water W1 decreases, the weight of the water tank 100 decreases, and the water tank 100 moves up. Therefore, the water head can be kept at the height h1.

The moisturizing cap device 50 has a cap holder 52, a cap portion 54 that is arranged on the cap holder 52 and protrudes in a Z-axis direction, and a sheet-like absorption member 56 that is arranged at a bottom portion of a space surrounded by the cap portion 54. The moisturizing cap device lift unit 60 is connected to the cap holder 52. The cap portion 54 may be made of, for example, synthetic rubber. The other end of the tube 102 passes through the cap portion 54 and reaches the absorption member 56. As the absorption member 56, for example, any member, such as urethane, PVA (polyvinyl alcohol) sponge or unwoven fabric, may be used insofar as it can absorb and retain water.

After printing is completed, when the carriage 10 returns from the printing area PA to the home position H1 and is put in the standby state, the moisturizing cap device lift unit 60 moves the moisturizing cap device 50 up. Then, the cap portion 54 comes into contact with a bottom surface S1 of the carriage 10, and a substantially closed space AR1 surrounded by the bottom surface S1, the cap portion 54, and the absorption member 56 is formed. At this time, the absorption member 56 retains moisture, and moisture is evaporated to humidify the space AR1. Therefore, it is possible to prevent residual ink on an ejection surface S2 of the head 14 or inside the nozzles (not shown) from being dried and thickened.

In the power-off state (standby state), a height h0 of a top surface S5 of the absorption member 56 is higher than a height h1 of the water head of the water W1 in the water tank 100. Therefore, in this state, the water W1 is not supplied from the water tank 100 to the moisturizing cap device 50 as a liquid. Meanwhile, the water W1 in the tube 102 is evaporated, and a very small amount of moisture is supplied to the absorption member 56.

The moisturizing cap device 50 corresponds to a first moisturizing cap device described in the appended claims. The water tank 100 and the tube 102 correspond to a first moisturizing liquid supply portion described in the appended claims. The water tank 100 corresponds to a first tank described in the appended claims. The water tank lift unit 110 and the moisturizing cap device lift unit 60 correspond to a lift portion described in the appended claims. The absorption member 56, the cap portion 54, or the cap holder 52 function as a first moisturizing liquid storage portion described in the appended claims.

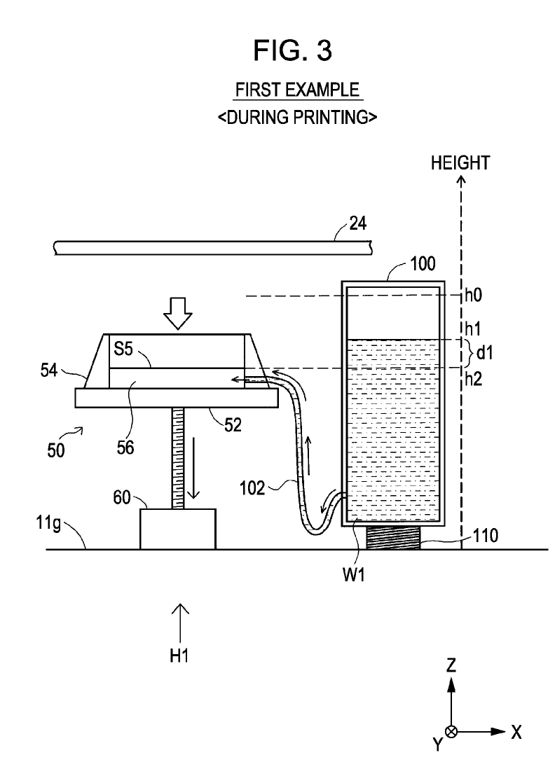

FIG. 3 is an explanatory view showing the detailed configuration of a portion near the home position H1 during printing according to the first example. If the carriage 10 is changed from the standby state (FIG. 2) to a printing execution state, the moisturizing cap device lift unit 60 moves the moisturizing cap device 50 down. Then, the carriage 10 (FIG. 1) is moved to the printing area PA. The moisturizing cap device lift unit 60 (FIG. 3) moves the moisturizing cap device 50 down such that the top surface S5 (FIG. 3) of the absorption member 56 is positioned at a height h2 lower than the height h1 of the water W1. Accordingly, the water W1 flows from the water tank 100 into the absorption member 56 due to the existence of a water head difference d1 (h1−h2) between the water W1 and the absorption member 56 (the water head of water absorbed by the absorption member 56). If water is retained only on the lower side of the absorption member 56, the water head difference d1 becomes larger than the water head difference between the top surface S5 of the absorption member 56 and the water W1. In this case, the water W1 also flows into the absorption member 56 due to the existence of a water head difference. In this way, even though moisture is evaporated and lost in the power-off state and the standby state (FIG. 2), water is supplied from the water tank 100 to the absorption member 56 during printing.

As described above, in the printer 1000, when the moisturizing cap device 50 is moved down before the carriage 10 is moved for printing, the position of the top surface S5 of the absorption member 56 becomes lower than the water head of the water W1 in the water tank 100. For this reason, a water head difference is formed between the absorption member 56 and the water W1, and the water W1 can be supplied to the absorption member 56 in accordance with the water head difference. Therefore, a large amount of water can be supplied to the moisturizing cap device 50, and as a result, the space AR1 of the moisturizing cap device 50 can be sufficiently humidified.

### SECOND EXAMPLE

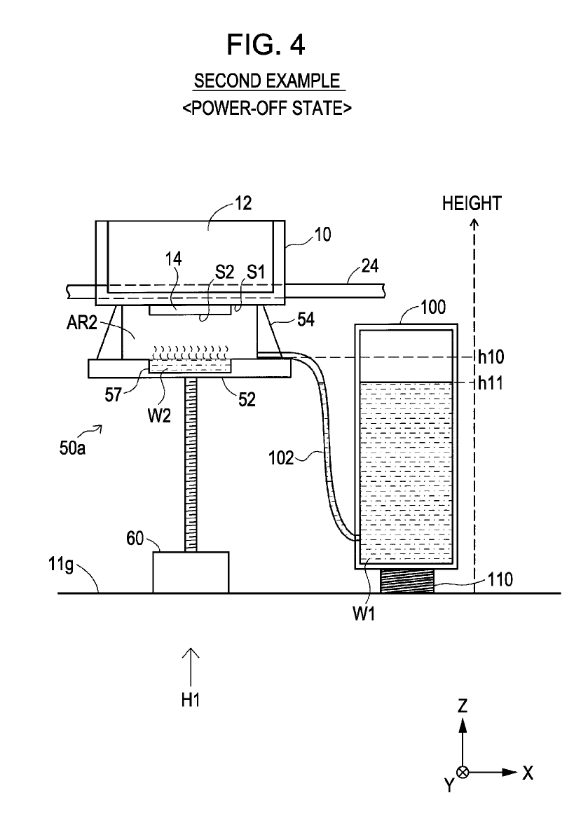

FIG. 4 is an explanatory view showing the detailed configuration of a portion near a home position H1 in a power-off state according to a second example. A printer of the second example has a moisturizing cap device different from that of the printer 1000 (FIGS. 1 to 3). Other parts are the same as those in the first example.

Specifically, a moisturizing cap device 50a of the second example has no absorption member therein. The cap holder 52 is provided with a concave portion 57 at a portion facing the space surrounded by the cap portion 54. In the power-off state and the standby state, water serving as a moisturizing liquid, that is, water W2 is retained in the concave portion 57. The water W2 is evaporated in a substantially closed space AR2 surrounded by the bottom surface S1 of the head 14, the cap portion 54, and the cap holder 52 to humidify the head 14. At this time, a top surface of the concave portion 57 (a surface of the cap holder 52 facing the space AR2) is positioned at a height h10 higher than a height h11 of the water W1 in the water tank 100. Therefore, the water W1 is not supplied from the water tank 100 to the moisturizing cap device 50.

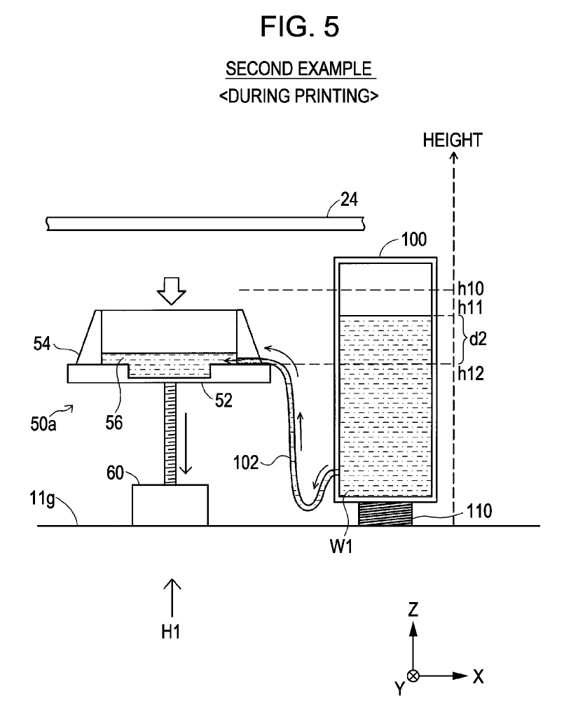

FIG. 5 is an explanatory view showing the detailed configuration of a portion near the home position H1 during printing according to the second example. Similarly to the first example, during printing, the carriage 10 is moved to the printing area PA, and the moisturizing cap device lift unit 60 moves the moisturizing cap device 50a down. At this time, the moisturizing cap device lift unit 60 moves the moisturizing cap device 50a down such that the top surface of the concave portion 57 (the surface of the cap holder 52 facing the space AR2) is positioned at a height h12 lower than the height h11 of the water W1. Accordingly, a water head difference d2 (h11−h12) is formed between the water W1 and the top surface of the concave portion 57, and thus the water W1 is supplied from the water tank 100 to the moisturizing cap device 50 through the tube 102. At this time, the water W1 may be supplied so as to exceed the allowable amount of the concave portion 57. In this case, the water W1 supplied to the moisturizing cap device 50 is retained in other portions surrounded by the cap portion 54, in addition to the concave portion 57. The moving-down distance of the moisturizing cap device 50a and the storage amount of the water W1 of the water tank 100 may be experimentally calculated in advance to an extent that the water W1 does not flow over the cap portion 54.

When the carriage 10 is put in the power-off state (standby state) again, the moisturizing cap device 50a is moved up and arranged as shown in FIG. 4. Accordingly, the position (height h10) of the top surface of the concave portion 57 (the top surface of the cap holder 52) becomes higher than the height h11 of the water W1 in the water tank 100. Therefore, the water W1 retained in the cap portion 54 is discharged to the water tank 100 through the tube 102. Meanwhile, the water W2 is retained in the concave portion 57 without being discharged to the water tank 100. As a result, in the power-off state (standby state), the water W2 is evaporated to humidify the space AR2, and thus ink stuck to the ejection surface S2 can be prevented from being dried.

As described above, in the second example, the water W1 is also supplied to the moisturizing cap device 50a in accordance with the water head difference d2 between the water W1 in the water tank 100 and the concave portion 57. Therefore, the printer of the second example has the same advantages as the printer 1000 of the first example.

### THIRD EXAMPLE

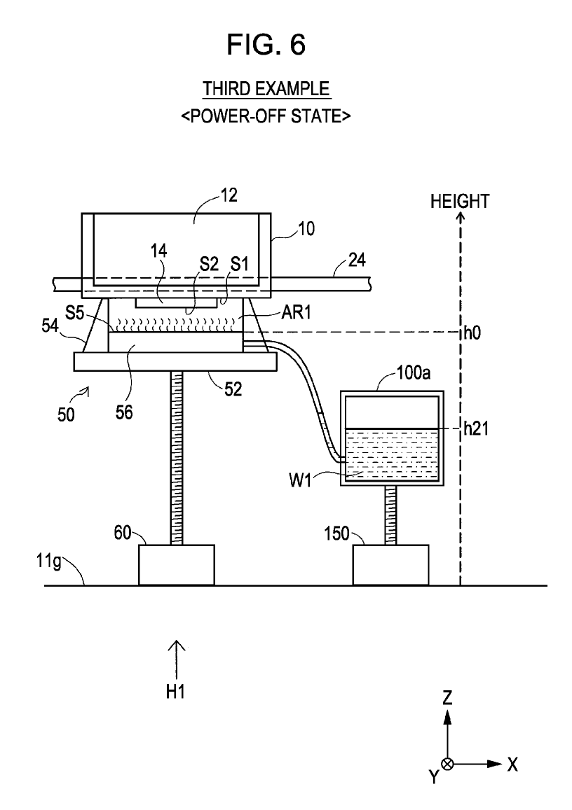

FIG. 6 is an explanatory view showing the detailed configuration of a portion near a home position H1 in a power-off state according to a third example. A printer of the third example is different from the printer 1000 (FIGS. 1 to 3) in that the height of the water head in the water tank is not constant. Other parts are the same as those in the first example.

Specifically, in the third example, a lift unit 150 having the same configuration as the moisturizing cap device lift unit 60, instead of the water tank lift unit 110 (FIG. 2) formed by a spring, is arranged below a water tank 100a as a lift unit. In the power-off state (standby state), the top surface S5 of the absorption member 56 in the moisturizing cap device 50 is positioned at a height h0 higher than a height h21 of the water W1 in the water tank 100a. Therefore, similarly to the first example, the water W1 is not supplied from the water tank 100a to the moisturizing cap device 50.

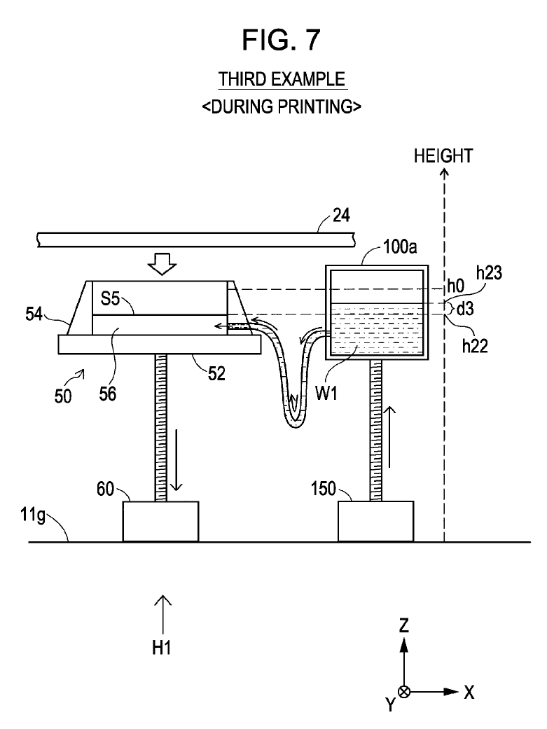

FIG. 7 is an explanatory view showing the detailed configuration of a portion near the home position H1 during printing according to the third example. Similarly to the first example, during printing, the carriage 10 is moved to the printing area PA, and the moisturizing cap device lift unit 60 moves the moisturizing cap device 50 down. The lift unit 150 moves the water tank 100a up. Accordingly, the top surface S5 of the absorption member 56 is positioned at a height h22, and the moving-down of the moisturizing cap device 50 and the moving-up of the water tank 100a are stopped when the water head of the water W1 in the water tank 100a is positioned at a height h23. At this time, a water head difference d3 (h23−h22) is formed between the absorption member 56 and the water W1 in the water tank 100a, such that the water W1 flows into the absorption member 56. Thereafter, when the carriage 10 is put in the power-off state (standby state), the lift unit 150 moves the water tank 100a down, and the moisturizing cap device lift unit 60 moves the moisturizing cap device 50 up.

As described above, in the third example, the water W1 is also supplied to the moisturizing cap device 50 in accordance with the water head difference between the water W1 in the water tank 100a and the absorption member 56. Therefore, the printer of the third example has the same advantages as the printer 1000 of the first example. In addition, the water W1 in the water tank 100a decreases in amount as it is supplied to the moisturizing cap device 50. For this reason, during printing, if the moving-up distance of the water tank 100a is gradually increased, the water head of the water W1 in the water tank 100a can become higher than the top surface S5 of the absorption member 56 in the moisturizing cap device 50.

### FOURTH EXAMPLE

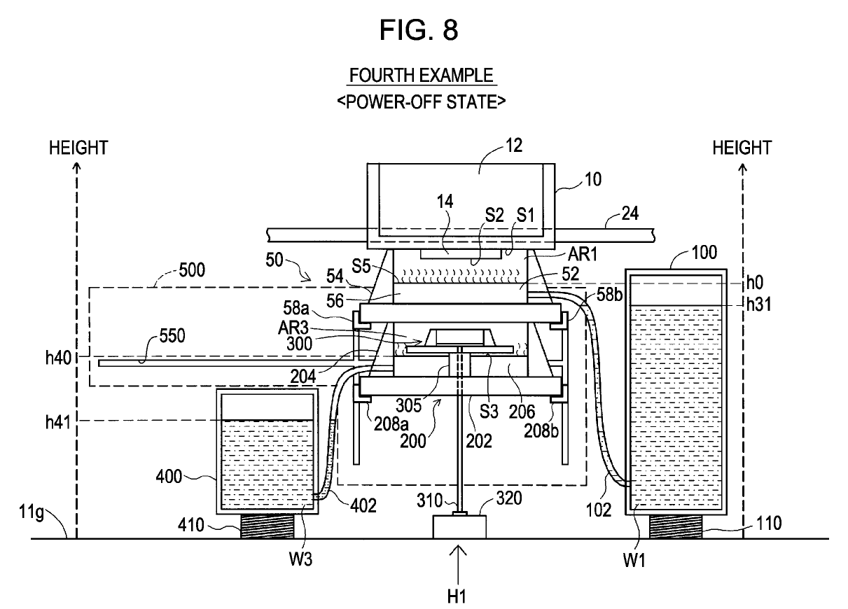

FIG. 8 is an explanatory view showing the detailed configuration of a portion near a home position H1 in a power-off state according to a fourth example. A printer of the fourth example is different from the printer 1000 (FIGS. 1 to 3) in terms of the following four respects, and other parts are the same as those in the first example. That is, the printer of the fourth example is different from the printer 1000 in that: a cap device 300 for suction and recovery and a second moisturizing cap device 200 serving as a cap device are provided, in addition to the moisturizing cap device 50 (hereinafter, referred to as a first moisturizing cap device 50); a water tank 400 for supplying water serving as a moisturizing liquid to the second moisturizing cap device 200 is provided; a moving mechanism 500 is provided, instead of the moisturizing cap device lift unit 60; and a pump 320 for forming negative pressure in the cap device 300 for suction and recovery is provided.

In the printer of the fourth example, suction and recovery for sucking and removing residual ink in the nozzles of the head 14 are executed separately from printing. When suction and recovery are executed, the cap device 300 for suction and recovery covers the ejection surface S2 of the head 14 and receives ink ejected from the nozzles. The pump 320 forms negative pressure in the cap device 300 for suction and recovery through a tube 310 such that residual ink in the nozzles is forcibly ejected.

The second moisturizing cap device 200 is a cap device that moisturizes the cap device 300 for suction and recovery. The reason why the cap device 300 for suction and recovery is moisturized is as follows. If the cap device 300 for suction and recovery is not moisturized, during suction and recovery, ink in the cap device 300 for suction and recovery is dried and thickened. Accordingly, a member for absorbing ink arranged in the cap device 300 for suction and recovery may become clogged, and the ink absorption ability thereof may be deteriorated. In addition, the suction force of the nozzles may be deteriorated.

The second moisturizing cap device 200 substantially has the same configuration as the first moisturizing cap device 50. That is, the second moisturizing cap device 200 has a cap holder 202, a cap portion 204, and an absorption member 206. A support member 305 is arranged at the center of the absorption member 206, and the cap device 300 for suction and recovery is arranged at an upper part of the support member 305. The cap device 300 for suction and recovery is different from the first moisturizing cap device 50 in that it is connected to the pump 320 without being connected to the water tank. Other parts of the cap device 300 for suction and recovery are the same as those in the first moisturizing cap device 50.

The first moisturizing cap device 50 is supported by two support members 58a and 58b from below. The two support members 58a and 58b are connected to the moving mechanism 500 through a sliding hole 550 in the frame 11 (FIG. 1). The moving mechanism 500 causes the two support members 58a and 58b to slide in a vertical or horizontal direction, thereby moving the first moisturizing cap device 50 in the vertical or horizontal direction. The moving mechanism 500 is arranged on a depth side of the sliding hole 550 (outside the frame 11).

Similarly, the second moisturizing cap device 200 is supported by two support members 208a and 208b from below. The two support members 208a and 208b are connected to the moving mechanism 500 through the sliding hole 550. The moving mechanism 500 causes the two support members 208a and 208b to slide in the vertical direction, thereby moving the second moisturizing cap device 200 in the vertical direction.

Water serving as a moisturizing liquid, that is, water W3 is retained in the water tank 400. Similarly to the water tank 100, the water tank 400 is connected to the second moisturizing cap device 200 (the absorption member 206) through a tube 402, and a water tank lift unit 410 is arranged below the water tank 400. Similarly to the water tank lift unit 110, the water tank lift unit 410 adjusts the position of the water tank 400 such that the water head of the water W3 in the water tank 400 is substantially kept at a height h41.

Suction and recovery correspond to preliminary ejection described in the appended claims. Printing corresponds to effective ejection described in the appended claims. The cap device 300 for suction and recovery corresponds to a cap device for preliminary ejection described in the appended claims. The second moisturizing cap device 200 corresponds to a second moisturizing cap device described in the appended claims. The water W3 corresponds to a second moisturizing liquid described in the appended claims. The water tank 400 and the tube 402 correspond to a second moisturizing liquid supply portion described in the appended claims. The absorption member 206 corresponds to a second moisturizing liquid storage portion described in the appended claims.

In the power-off state and the standby state, the first moisturizing cap device 50 comes into contact with the bottom surface S1 of the carriage 10, and similarly to the first example, a substantially closed space AR1 is formed. Then, moisture is evaporated from the absorption member 56, and ink stuck to the ejection surface S2 of the head 14 is prevented from being dried. At this time, the height h0 of the top surface S5 of the absorption member 56 is higher than a height h31 of the water head of the water W1 in the water tank 100. Therefore, similarly to the first example, the water W1 is not supplied from the water tank 100 to the first moisturizing cap device 50.

The second moisturizing cap device 200 also comes into contact with a bottom surface of the first moisturizing cap device 50 (a bottom surface of the cap holder 52) by the cap portion 204. Accordingly, a substantially closed space AR3 surrounded by the bottom surface of the cap holder 52, the cap portion 204, and the absorption member 206 is formed. Then, moisture absorbed by the absorption member 206 is evaporated, and the space AR3 is humidified. Therefore, ink in the cap device 300 for suction and recovery can be prevented from being dried. In the power-off state (standby state), a height h40 of a top surface S3 of the absorption member 206 is higher than the height h41 of the water W3 in the water tank 400. Therefore, the water W3 is not supplied from the water tank 400 to the absorption member 206.

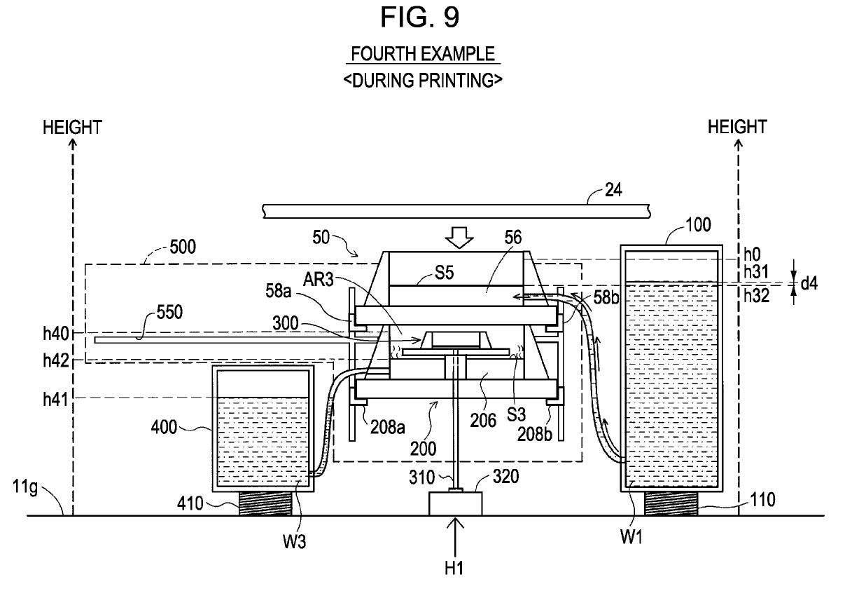

FIG. 9 is an explanatory view showing the detailed configuration of a portion near the home position H1 during printing according to the fourth example. When printing is started, the moving mechanism 500 moves the first moisturizing cap device 50 and the second moisturizing cap device 200 down simultaneously at the same speed. As a result, the space AR3 is not opened, and the humidity in the space AR3 is maintained. At this time, the moving mechanism 500 moves the first moisturizing cap device 50 down (and the second moisturizing cap device 200) such that a height h32 of the top surface S5 of the absorption member 56 in the first moisturizing cap device 50 becomes lower than the height h31 of the water head of the water W1 in the water tank 100. For this reason, a water head difference d4 (h31−h32) is formed between the absorption member 56 and the water head of the water W1 in the water tank 100, and the water W1 is supplied from the water tank 100 to the moisturizing cap device 50.

At this time, in the second moisturizing cap device 200, the top surface S3 of the absorption member 206 is positioned at a height h42 higher than the height h41 of the water head of the water W3 in the water tank 400. Therefore, the water W3 is not supplied from the water tank 400 to the second moisturizing cap device 200.

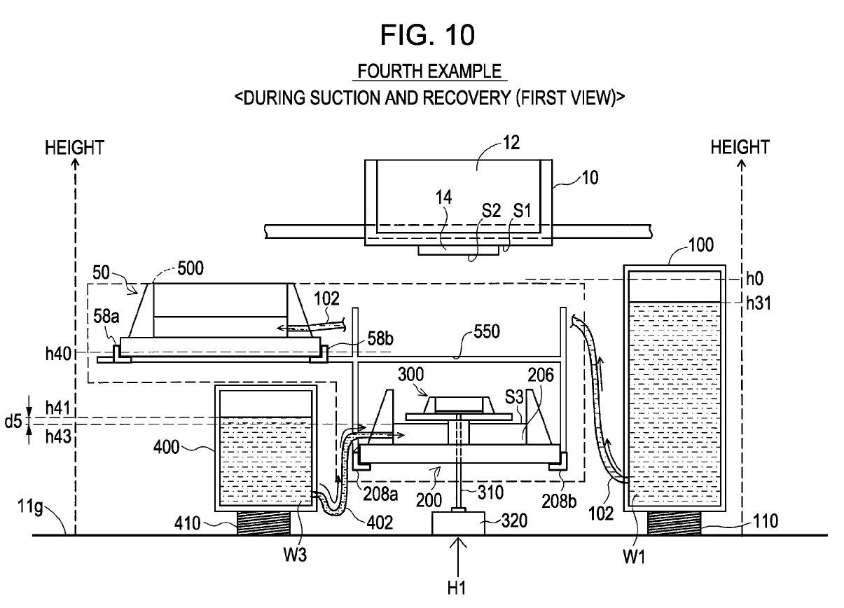

FIG. 10 is an explanatory view showing the detailed configuration of a portion near the home position H1 during suction and recovery according to the fourth example. When the carriage 10 is changed from the standby state (FIG. 8) to a state for suction and recovery, the moving mechanism 500 first slightly moves the first moisturizing cap device 50 and the second moisturizing cap device 200 down. Thereafter, the moving mechanism 500 moves the first moisturizing cap device 50 from the home position H1 leftward, and further moves the second moisturizing cap device 200 at the home position H1 down. At this time, the moving mechanism 500 moves the second moisturizing cap device 200 down such that a height h43 of the top surface S3 of the absorption member 206 becomes lower than the height h41 of the water head of the water W3 in the water tank 400. Therefore, a water head difference d5 (h41−h43) is formed between the absorption member 206 and the water W3 in the water tank 400, and thus the water W3 is supplied from the water tank 400 to the second moisturizing cap device 200 (the absorption member 206).

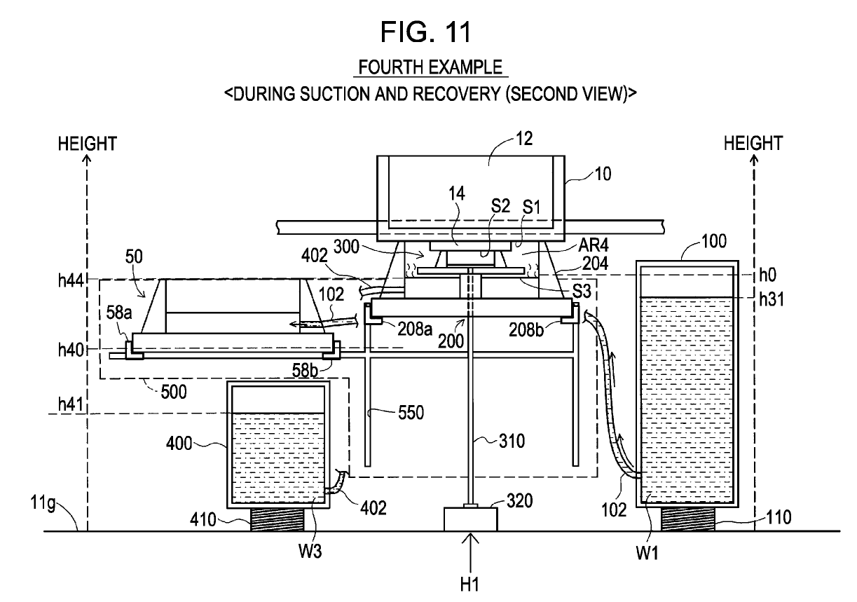

FIG. 11 is an explanatory view showing the detailed configuration of a portion near the home position H1 during suction and recovery according to the fourth example. FIG. 11 shows a state later than the state shown in FIG. 10. The moving mechanism 500 moves the second moisturizing cap device 200 down to a position shown in FIG. 10 to cause the water W3 to be supplied to the absorption member 206, and in turn moves the second moisturizing cap device 200 up. Then, if the cap portion 204 of the second moisturizing cap device 200 comes into contact with the bottom surface S1 of the carriage 10, the moving mechanism 500 stops the moving-up of the second moisturizing cap device 200. Next, the pump 320 forms negative pressure in the cap device 300 for suction and recovery, and residual ink is sucked from the nozzles (not shown) of the head 14. At this time, a height h44 of the top surface S3 of the absorption member 206 becomes higher than the height h41 of the water head of the water W3 in the water tank 400, and the water W3 is not supplied to the absorption member 206.

As described above, in the fourth example, the water W1 is also supplied to the moisturizing cap device 50 in accordance with the water head difference d4 between the water W1 in the water tank 100 and the absorption member 56. Therefore, the printer of the fourth example has the same advantages as the printer 1000 of the first example. In addition, in the power-off state (standby state) and during printing, the cap device 300 for suction and recovery is covered with the second moisturizing cap device 200 and moisturized. Therefore, during suction and recovery, it is possible to prevent ink in the cap device 300 for suction and recovery from being dried, and it is possible to prevent the ink absorption ability in the cap device 300 for suction and recovery and the suction force of the nozzles from being deteriorated. Furthermore, the water W3 is supplied to the second moisturizing cap device 200 in accordance with the water head difference d5 between the water W3 in the water tank 400 and the absorption member 206. As a result, the spaces AR3 and AR4 in the second moisturizing cap device 200 can be sufficiently humidified.

### FIFTH EXAMPLE

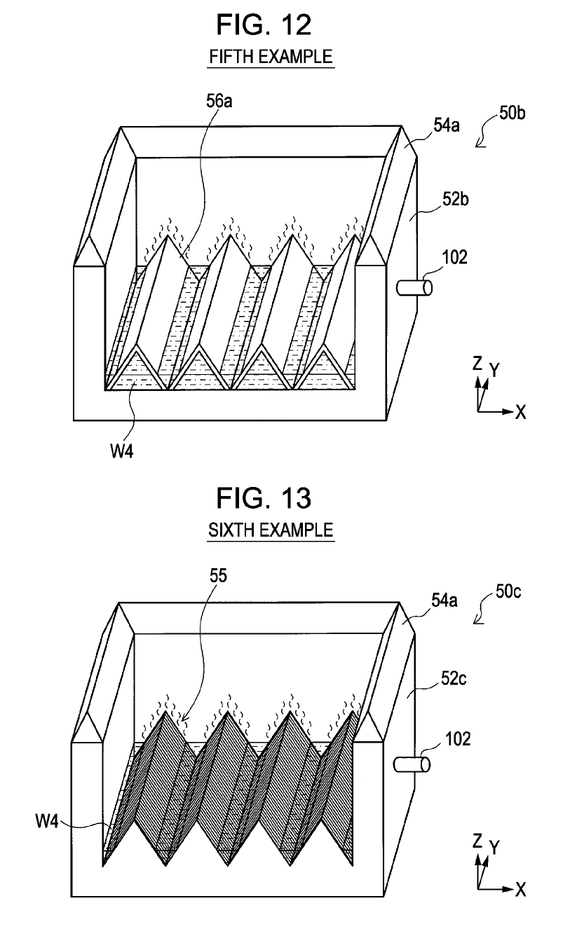

FIG. 12 is an explanatory view showing the detailed configuration of a moisturizing cap device according to a fifth example. In FIG. 12, for convenience of explanation, part of a wall on a near side of a moisturizing cap device 50b is not shown. A printer of the fifth example has a moisturizing cap device 50b different from the printer 1000 (FIGS. 1 to 3). Other parts are the same as those in the first example.

Specifically, the moisturizing cap device 50b has a square-shaped cap holder 52b, a cap portion 54a formed along an upper end portion of the cap holder 52b, and an absorption member 56a arranged in the cap holder 52b. The cap portion 54a may be formed by, for example, an elastic member, such as rubber. The absorption member 56a has a sheet-like shape, which is formed by folding a plate member made of urethane in a concavo-convex shape, and is arranged at a bottom portion of the cap holder 52b.

When the water W1 in the water tank 100 is supplied to the moisturizing cap device 50b, in the example of FIG. 12, a part of the absorption member 56a (dent portion) is soaked in water W4 in the cap holder 52b. Then, the water W4 absorbed at the dent portion of the absorption member 56a is raised to a crest portion of the absorption member 56a by a capillary force and is diffused over the absorption member 56a. In the power-off state (standby state), the water W4 absorbed by the absorption member 56a is evaporated and humidifies the inside of the cap holder 52b. In the fifth example, the cap holders 52b and 56a correspond to a first moisturizing liquid storage portion described in the appended claims.

As such, in the moisturizing cap device 50b, the absorption member 56a has a concavo-convex shape (a folded shape), and thus the surface area can be increased, as compared with a case in which an absorption member has a flat plate shape. Therefore, the amount of moisture to be evaporated per unit time can be increased, as compared with a case in which an absorption member has a flat plate shape, and the inner space of the cap holder 52b can be formed at high humidity within a short time. The absorption member 56a is not limited to a folded shape, but it may have any concavo-convex shape having a surface area larger than a planar shape. The moisturizing cap device 50b may also be applied to the printer of the third or fourth example.

### SIXTH EXAMPLE

FIG. 13 is an explanatory view showing the detailed configuration of a moisturizing cap device according to a sixth example. A printer of the sixth example is different from the printer of the fifth example in that a moisturizing cap device 50c does not have an absorption member 56a, a bottom surface 55 of a cap holder 52c has a concavo-convex shape, and a small groove is provided in a vertical direction over the entire bottom surface 55. Other parts are the same as those in the fifth example. In the sixth example, the cap holder 52c corresponds to a first moisturizing liquid storage portion described in the appended claims.

With this configuration, similarly to the fifth example, the surface area of a portion in the cap holder 52c to be in contact with the water W4 or a portion where the water W4 is evaporated in the power-off state can be increased, as compared with a case in which the bottom surface of an absorption member or a cap holder has a flat plate shape. Therefore, the inner space of the cap holder 52c can be formed at high humidity within a comparatively short time. The moisturizing cap device 50c may also be applied to the printer of each of the first to fourth examples.

### SEVENTH EXAMPLE

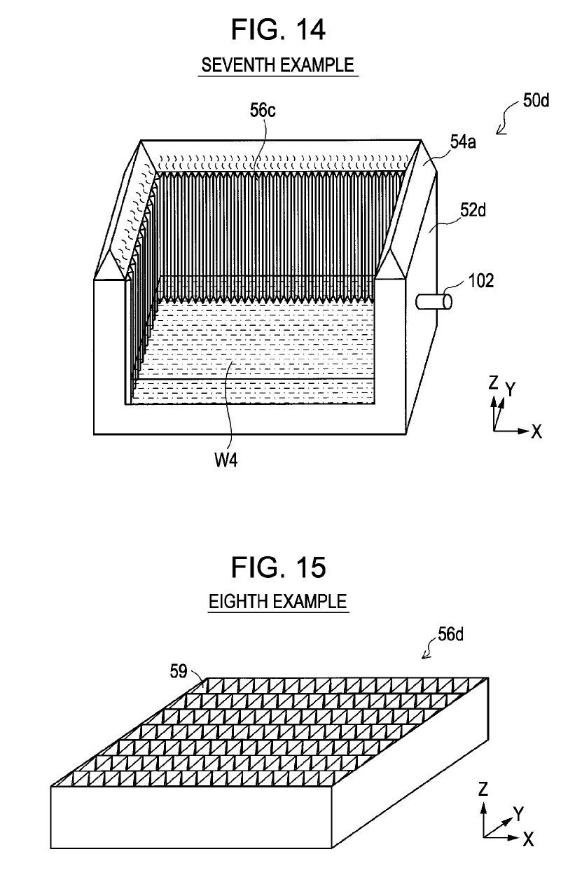

FIG. 14 is an explanatory view showing the detailed configuration of a moisturizing cap device according to a seventh example. A printer of the seventh example is different from the printer of the sixth example in that a side surface 56c from among the inner surfaces of a cap holder 52d in a moisturizing cap device 50d has a concavo-convex shape. Other parts are the same as those in the sixth example. The printer of the seventh example having such a configuration has the same advantages as the printer of the sixth example. The moisturizing cap device 50d may also be applied to the printer of each of the first to fifth examples. In the seventh example, the cap holder 52d corresponds to a first moisturizing liquid storage portion described in the appended claims.

### EIGHTH EXAMPLE

FIG. 15 is an explanatory view showing the detailed configuration of an absorption member used for a moisturizing cap according to an eighth example. A printer of the eighth example has an absorption member having a shape different from that in the printer 1000 (FIGS. 1 to 3). Other parts are the same as those in the first example.

Specifically, an absorption member 56d of the eighth example has a so-called honeycomb structure in which a plurality of sheets 59 each formed by folding the same plate-shaped absorption member as that in the fifth example are arranged in a Y-axis direction. With the absorption member 56d having the honeycomb structure, the surface area of the absorption member 56d can be made comparatively large, and the amount of moisture to be evaporated per unit time can be increased. Therefore, the inner space AR1 of the cap holder 52 can be formed at high humidity within a short time. In the eighth example, the cap portion 54 (FIG. 2) and the absorption member 56d (FIG. 15) correspond to a first moisturizing liquid storage portion described in the appended claims. The absorption member 56d may also be applied to the printer of the third or fourth example.

### Modifications

Elements other than the elements described in the independent claims from among the elements in the individual examples are additional elements, and may be appropriately omitted. The invention is not limited to the foregoing examples or embodiments, but it may be embodied in various ways without departing from the spirit of the invention. For example, the following modifications may be made.

### Modification 1

In the foregoing examples, in the power-off state (standby state), the height of the top surface of the absorption member (the first example or the like) or the height of the top surface of the concave portion 57 (the second example), that is, the water head of water retained in the moisturizing cap device is higher than the water head of the water W1 in the water tank. Alternatively, the water head of water retained in the moisturizing cap device may be lower than the water head of the water W1. In the first example, if the water head of the water W1 in the water tank 100 (FIG. 2) is set to be positioned between the top surface S5 of the absorption member 56 and the ejection surface S2 of the head 14, in the power-off state (standby state), the head 14 is not soaked in water. In general, any configuration in which the water head of the water W1 in the water tank is positioned higher than the water head of water retained in the moisturizing cap device when the water W1 (moisturizing liquid) in the water tank is supplied to the moisturizing cap device may be applied to the fluid ejecting apparatus of the invention.

### Modification 2

In the foregoing fourth example, a cap device which is used as cap device for preliminary ejection is the cap device 300 for suction and recovery. Alternatively, instead of the cap device 300 for suction and recovery or together with the cap device 300 for suction and recovery, a flushing box (not shown) may be used. The flushing box is a cap device that, when a flushing operation is executed to eject a predetermined amount of ink from all the nozzles and to remove thickened ink, receives ejected ink. In general, a cap device for preliminary ejection may be used in the fluid ejecting apparatus of the invention.

### Modification 3

In the foregoing examples, the water tank lift units 110 and 410 are used in order to make the water head of the water W1 in the water tank 100 or 100a and the water head of the water W3 in the water tank 400 constant. Alternatively, water may be supplied to the water tank 100, 100a, or 400 by a pump by the decreased amount. In this case, a predetermined amount of water may be supplied by the pump at a fixed time interval.

### Modification 4

In the foregoing examples, water is supplied from the water tank 100 or 100a to the moisturizing cap device 50, 50a, 50b, 50c, or 50d during printing or during suction and recovery (the fourth example). Alternatively, a timing at which water is supplied may be provided separately from the timing for printing or suction and recovery. Specifically, while printing or suction and recovery is not executed, the moisturizing cap device 50, 50a, 50b, 50c, or 50d may be moved down or the water tank 100a may be moved up.

### Modification 5

In the foregoing examples, in the power-off state (standby state) the moisturizing cap device 50, 50a, 50b, 50c, or 50d comes into contact with the bottom surface S1 of the carriage 10. Alternatively, the moisturizing cap device may come into contact with the ejection surface S2 of the head 14, instead of the bottom surface S1. In this case, if the cap portion 54 is arranged so as to surround a region of the ejection surface S2 where the ejection holes of the nozzles are formed, it is also possible to prevent ink stuck to near the nozzles from being dried.

### Modification 6

In the foregoing examples, a single head 14 is provided at the bottom surface S1 of the carriage 10. Alternatively, two heads or more may be provided. In this case, if the moisturizing cap device 50, 50a, 50b, 50c, or 50d is arranged so as to cover at least some of the plurality of heads, it is possible to prevent residual ink from being dried in the covered heads. In addition, when a plurality of cap devices 300 for suction and recovery (FIG. 8) are provided to correspond to the plurality of heads, the second moisturizing cap device 200 may be arranged so as to cover at least some of the plurality of cap devices 300 for suction and recovery.

### Modification 7

In the foregoing second example, a single concave portion 57 is formed at the top surface of the cap holder 52, but the number of concave portions 57 is not limited to one. That is, a plurality of concave portions may be provided. In addition, sponge made of urethane may be arranged in the concave portion 57. In general, any moisturizing head cap device that has a moisturizing liquid storage portion for retaining water to be supplied from the water tank 100 or 100a may be applied to the fluid ejecting apparatus of the invention.

### Modification 8

In the foregoing third example, during printing, the moisturizing cap device 50 is moved down and at the same time, the water tank 100a is moved up, thereby making the water head difference d3. Alternatively, a water head difference may be formed only by moving the water tank 100a up. In this case, the position of the moisturizing cap device 50 during printing is the same as the position in the power-off state (standby state), the moisturizing cap device 50 interferes with the movement of the carriage 10 on the printing area PA. Therefore, printing may be executed by moving the guide member 24 up together with the carriage 10 and moving the carriage 10 on the printing area PA.

### Modification 9

In the foregoing examples, the water tank 100 or 100a is moved down or the moisturizing cap device 50, 50a, 50b, 50c, or 50d is moved up in order to generate the water head difference, but the invention is not limited thereto. For example, while the positions of the water tank and the moisturizing cap device leave unchanged, the water head of water in the water tank may be raised only when water is supplied to the moisturizing cap device. In this case, for example, a water head difference may be generated by supplying water to the water tank by using a pump to raise the water head of the water W1 or by discharging water from the water tank by using a pump to fall down the water head of the water W1. In general, any configuration may be applied to the fluid ejecting apparatus of the invention insofar as a water head difference is generated between water (moisturizing liquid) in the water tank and water in the moisturizing cap device.

### Modification 10

In the foregoing examples, an ink jet printer has been described. However, the invention is not limited to the ink jet printer, and it may be applied to a fluid ejecting apparatus that ejects a fluid (including a liquid, a liquid-state material with particles of a functional material dispersed, or a solid, such as powder capable of flowing and being ejected as a fluid) other than ink. For example, the invention may be applied to a liquid-state material ejecting apparatus that ejects a liquid-state material having dispersed or dissolved a material, such as an electrode material or a color material used in manufacturing a liquid crystal display, an EL (Electro Luminescence) display, or a field emission display. In addition, the invention may be applied to a liquid ejecting apparatus that ejects a biological organic material used in manufacturing a biochip, a liquid ejecting apparatus that ejects a liquid serving as a sample used as a precision pipette, a liquid ejecting apparatus that pinpoint ejects a lubricant to a precision instrument, such as a watch or a camera, a liquid ejecting apparatus that ejects on a substrate a transparent resin liquid, such as UV curable resin, to form a fine hemispheric lens (optical lens) for an optical communication element, a liquid ejecting apparatus that ejects an etchant, such as acid or alkali, to etch a substrate, or an ejecting apparatus that ejects a solid, for example, powder such as toner.

What is claimed is:

1. A fluid ejecting apparatus that ejects a fluid, the fluid ejecting apparatus comprising:
a head that ejects the fluid;
a first moisturizing cap device that covers the head to moisturize the head;
a first moisturizing liquid supply portion that supplies, to the first moisturizing cap device, a first moisturizing liquid for moisturizing the head when the first moisturizing cap device covers the head,
wherein the first moisturizing liquid supply portion has a first tank that stores the first moisturizing liquid,
the first moisturizing cap device has a first moisturizing liquid storage portion that stores the first moisturizing liquid to be supplied from the first moisturizing liquid supply portion, and
the first moisturizing liquid supply portion supplies the first moisturizing liquid stored in the first tank to the first moisturizing cap device in accordance with a water head difference between the first moisturizing liquid stored in the first tank and the first moisturizing liquid storage portion.

2. The fluid ejecting apparatus according to claim 1,
wherein, when the first moisturizing liquid supply portion supplies the first moisturizing liquid stored in the first tank to the first moisturizing cap device, the water head of the first moisturizing liquid stored in the first tank becomes higher than the water head of the first moisturizing liquid stored in the first moisturizing liquid storage portion, and
when the first moisturizing liquid supply portion does not supply the first moisturizing liquid stored in the first tank to the first moisturizing cap device, the water head of the first moisturizing liquid stored in the first tank becomes lower than the water head of the first moisturizing liquid stored in the first moisturizing liquid storage portion.

3. The fluid ejecting apparatus according to claim 1,
wherein the first moisturizing cap device has an absorption member that is capable of absorbing the first moisturizing liquid, and
when the first moisturizing liquid supply portion supplies the first moisturizing liquid to the first moisturizing cap device, the position of a top surface of the absorption member becomes lower than the water head of the first moisturizing liquid stored in the first tank.

4. The fluid ejecting apparatus according to claim 1,
the first moisturizing cap device has a hollow shape,
the first moisturizing liquid storage portion is formed by a concave portion that is formed at a bottom portion of the first moisturizing cap device, and
when the first moisturizing liquid supply portion supplies the first moisturizing liquid to the first moisturizing cap device, the position of a top surface of the concave portion becomes lower than the water head of the first moisturizing liquid stored in the first tank.

5. The fluid ejecting apparatus according to claim 1, further comprising:
a lift portion that raises and lowers at least one of the first moisturizing cap device and the first tank,
wherein the first moisturizing liquid supply portion moves the first moisturizing cap device down or moves the first tank up by using the lift portion to supply the first moisturizing liquid stored in the first tank to the first moisturizing cap device in accordance with the water head difference.

6. The fluid ejecting apparatus according to claim 1, further comprising:
a cap device for preliminary ejection that receives the fluid when the head executes preliminary ejection separately from effective ejection, in which the fluid is ejected onto an object to be processed disposed at a predetermined position;
a second moisturizing cap device that covers the cap device for preliminary ejection to moisturize the cap device for preliminary ejection; and
a second moisturizing liquid supply portion that supplies a second moisturizing liquid for moisturizing the cap device for preliminary ejection to the second moisturizing cap device,
wherein the second moisturizing liquid supply portion has a second tank that stores the second moisturizing liquid,
the second moisturizing cap device has a second moisturizing liquid storage portion that stores the second moisturizing liquid to be supplied from the second moisturizing liquid supply portion,
the cap device for preliminary ejection is disposed in the second moisturizing cap device,
the second moisturizing cap device comes into contact with the bottom of the first moisturizing cap device and is stacked on the first moisturizing cap device in order to moisturize the cap device for preliminary ejection, and
the second moisturizing liquid supply portion supplies the second moisturizing liquid stored in the second tank to the second moisturizing cap device in accordance with a water head difference between the second moisturizing liquid stored in the second tank and the second moisturizing liquid storage portion.

7. The fluid ejecting apparatus according to claim 1,
wherein the fluid is a liquid.

8. A fluid ejecting apparatus that ejects a fluid, the fluid ejecting apparatus comprising:
a head that ejects the fluid; and
a first moisturizing cap device that covers the head to moisturize the head,
wherein the first moisturizing cap device has a first moisturizing liquid storage portion that stores a first moisturizing liquid for moisturizing the head when the first moisturizing cap device covers the head, and
the inside of the first moisturizing liquid storage portion at least partially has a concavo-convex shape.

9. The fluid ejecting apparatus according to claim 8,
wherein a groove is at least partially provided to be directed upward at an inner wall of the first moisturizing liquid storage portion in order to promote evaporation of the first moisturizing liquid.

10. The fluid ejecting apparatus according to claim 7,
wherein the first moisturizing liquid storage portion has an absorption member that is capable of absorbing the first moisturizing liquid, and
the absorption member has a concavo-convex shape.
